(19) United States
(12) Patent Application Publication
(10) Pub. No.: US 2007/0202026 A1
(43) Pub. Date: Aug. 30, 2007

(54) Exhaust Gas Purifying Method And Exhaust Gas Purifying Apparatus For Internal Combustion Engine

(75) Inventors: Kohei Yoshida, Susono-shi (JP); Shinya Hirota, Susono-shi (JP); Yasuaki Nakano, Sunto-gun (JP)

Correspondence Address: OLIFF & BERRIDGE, PLC, P.O. BOX 19928, ALEXANDRIA, VA, 22320, US

(73) Assignee: Toyota Jidosha Kabushiki Kaisha, Toyota-shi, Aichi-ken (JP)

(21) Appl. No.: 10/592,081

(22) PCT Filed: Dec. 9, 2005
(86) PCT No.: PCT/JP05/23099

§ 371 Date: Sep. 7, 2006

(30) Foreign Application Priority Data
Dec. 13, 2004 (JP) 2004-360473

(51) Int. Cl. B01D 53/94

(52) U.S. Cl. 423/212; 423/220; 423/235

(57) ABSTRACT

The invention provides a technology that enables to prevent sulfur components contained in reducing agent added from flowing into an NOx catalyst thereby keeping a high NOx removing rate. An S-trapping catalyst 11 for trapping sulfur components contained in exhaust gas discharged from an internal combustion engine 1, an S-trapping catalyst 12 for trapping sulfur components contained in reducing agent added to the exhaust gas from which sulfur components have been trapped by the S-trapping catalyst 11 are provided, thereby preventing an NOx catalyst 14 from being poisoned by sulfur.

### BACKGROUND OF THE INVENTION

1. Technical Field

The present invention relates to an exhaust gas purifying method and an exhaust gas purifying apparatus for an internal combustion engine.

2. Background Art

A known exhaust gas purifying apparatus for a conventional internal combustion engine has a sulfur component keeping agent that traps and keeps sulfur components provided in the upstream of an NOx keeping agent that traps and keeps NOx (nitrogen oxides) contained in exhaust gas, and reducing agent adding means for adding a reducing (or deoxidizing) agent to the exhaust gas flowing into the NOx keeping agent, wherein the concentration of the sulfur components contained in the reducing agent added by the reducing agent adding means is made lower than the concentration of the sulfur components contained in the fuel supplied to the combustion chamber of the internal combustion engine to prevent the NOx agent from being poisoned by sulfur (see, for example, patent document 1 (Japanese Patent Application Laid-Open No. 2004-60596), patent document 2 (Japanese Patent Application Laid-Open No. 2000-291422), patent document 3 (Japanese Patent Application Laid-Open No. 07-270330), patent document 4 (Japanese Patent Application Laid-Open No. 2003-13732) and patent document 5 (Japanese Patent Application Laid-Open No. 06-58138)).

However, it is difficult to reduce the concentration of sulfur components in the reducing agent added by the reducing agent adding means to zero. Therefore, even in exhaust gas purifying apparatuses having the above-described configuration, there is a concern that the NOx keeping agent may be poisoned by sulfur to invite a decrease in the NOx removing rate.

### DISCLOSURE OF THE INVENTION

The present invention has been made in view of the above-described situation and has as an object to provide a technology for preventing sulfur components contained in the added reducing agent from flowing into the NOx catalyst, thereby enabling to keep a high NOx removing rate.

To achieve the above object, the present invention is mainly characterized by a step of trapping sulfur components contained in exhaust gas discharged from an internal combustion engine and a step of trapping sulfur components contained in reducing agent added to the exhaust gas from which sulfur components have been trapped by the above-mentioned step, whereby a catalyst having an NOx storing ability is prevented from being poisoned by sulfur, more reliably.

Specifically, an exhaust gas purifying method for an internal combustion engine according to the present invention comprises:

a first step of trapping sulfur components contained in exhaust gas discharged from an internal combustion engine;

a second step of trapping NOx contained in the exhaust gas from which sulfur components have been trapped in said first step;

a third step of adding, in response to a reducing agent addition request, a reducing agent to the exhaust gas from which sulfur components have been trapped in said first step;

a fourth step of trapping sulfur components contained in the exhaust gas to which the reducing agent has been added in said third step; and

a fifth step of reducing NOx trapped in said second step by means of the reducing agent from which sulfur components have been trapped in said fourth step.

According to this method, it is possible to trap sulfur components contained in the exhaust gas discharged from the internal combustion engine through the first step. Furthermore, when a reducing agent is added in response to a reducing agent addition request, it is possible to trap sulfur components contained in the exhaust gas to which the reducing agent has been added, through the fourth step. Therefore, it is possible to prevent the catalyst having an NOx storing ability from being poisoned by sulfur, thereby keeping a high NOx removing rate.

Here, a description will be made of the reducing agent addition request. Addition of reducing agent is required, for example, when regeneration processing for the catalyst having an NOx storing ability is to be effected. The regeneration processing for the catalyst may be, for example, a processing for reductively removing NOx stored (or absorbed) in the catalyst.

It is preferred that the method further comprise a step of activating the reducing agent from which sulfur components have been trapped before reducing, in said fifth step, NOx trapped in said second step by means of the reducing agent from which sulfur components have been trapped in said fourth step.

According to this method, reactivity of the reducing agent can be enhanced, and the efficiency of reduction of NOx can be improved. Thus, it is possible to further enhance the NOx removing rate.

Specifically, an exhaust gas purifying apparatus for an internal combustion engine according to the present invention comprises:

first sulfur trapping means provided in an exhaust passage of an internal combustion engine for trapping sulfur components contained in exhaust gas discharged from the internal combustion engine;

a catalyst provided downstream of said first sulfur trapping means for trapping NOx contained in the exhaust gas from which sulfur components have been trapped by said first sulfur trapping means;

reducing agent adding means for adding, in response to a reducing agent addition request, a reducing agent to the exhaust gas from which sulfur components have been trapped by said first sulfur trapping means, at a position upstream of said catalyst; and

second sulfur trapping means for trapping sulfur components contained in the reducing agent added by said reducing agent adding means, at a position upstream of said catalyst.

According to this configuration, it is possible to trap sulfur components contained in the exhaust gas discharged from the internal combustion engine by means of the first sulfur trapping means. Furthermore, in the case where reducing agent is added in response to a reducing agent addition request, it is possible to trap sulfur components contained in the exhaust gas to which the reducing agent has been added, by the second sulfur trapping means. Therefore, it is possible to prevent the catalyst having an NOx storing ability from being poisoned by sulfur, thereby keeping a high NOx removing rate.

In the above configuration, it is preferred that reducing agent activating means for activating the reducing agent from which sulfur components have been trapped by the second sulfur trapping means be further provided between said second sulfur trapping means and said catalyst.

According to this configuration, reactivity of the reducing agent can be enhanced, and the efficiency of reduction of NOx can be improved. Thus, it is possible to further improve the NOx removing rate.

It is preferred that said second sulfur trapping means and said reducing agent activating means be provided integrally with said catalyst.

An exhaust gas purifying apparatus for an internal combustion engine according to another aspect of the present invention comprises:

sulfur trapping means provided in an exhaust passage of an internal combustion engine for trapping sulfur components contained in exhaust gas discharged from the internal combustion engine;

a catalyst provided downstream of said sulfur trapping means for trapping NOx contained in the exhaust gas from which sulfur components have been trapped by said sulfur trapping means; and

reducing agent adding means for adding, in response to a reducing agent addition request, a reducing agent to the exhaust gas from which sulfur components have been trapped by said sulfur trapping means, at a position upstream of said catalyst,

wherein both ends regions of said catalyst have an NOx storage capacity larger than that of an inner region of the catalyst.

According to this configuration, it is possible to trap sulfur components contained in exhaust gas discharged from the internal combustion engine by the sulfur trapping means. Furthermore, in the case where reducing agent is added in response to a reducing agent addition request, it is possible to trap sulfur components contained in the exhaust gas to which the reducing agent has been added, by the upstream region among both end regions of the catalyst. In addition, it is possible to trap NOx contained in the exhaust gas by the downstream region among both end regions of the catalyst. The inner region of the catalyst has an NOx storing capacity smaller than those of both end regions of the catalyst. When such an inner region is provided, it is possible to activate the reducing agent more effectively than in the case where such an inner region is not provided. Accordingly, the efficiency of reduction of NOx can be enhanced, and it is possible to further improve the NOx removing rate.

In this configuration, it is preferred that the upstream region among said both end regions of said catalyst have an NOx storage capacity larger than that of the downstream region among said both end regions.

According to this configuration, it is possible to trap sulfur components contained in the exhaust gas to which the reducing agent has been added more reliably in the upstream region of the catalyst. Both the end regions and the inner region may be constructed as separate catalysts provided in a single casing or as regions of catalyst supported on a common substrate.

The catalyst having an NOx storing ability may be, for example, an NOx storage reduction catalyst. The NOx storage reduction catalyst may be supported on a particulate filter for trapping particulate matter (PM) such as soot contained in exhaust gas.

As per the above, according to the present invention, it is possible to prevent sulfur components contained in added reducing agent from flowing into the NOx catalyst, and it is possible to keep a high NOx removing rate.

### BRIEF DESCRIPTION OF THE DRAWINGS

FIG. 1 schematically shows an internal combustion engine according to embodiment 1.

FIG. 2 shows the NOx storage capacity of an exhaust gas purifying portion of the internal combustion engine according to the embodiment of the present invention.

FIG. 3 schematically shows an internal combustion engine according to embodiment 2.

### DESCRIPTION OF THE EMBODIMENT

In the following, the best mode for carrying out the present invention will be described in detail with reference to the drawings.

### Embodiment 1

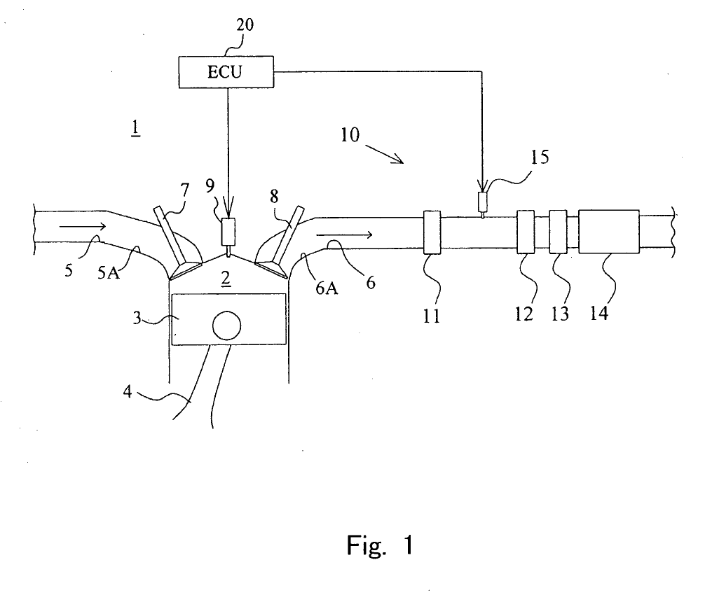

FIG. 1 schematically shows an internal combustion engine 1 in the form of a diesel engine according to embodiment 1 of the present invention.

The internal combustion engine 1 is a diesel engine that operates in four cycles, namely the intake, compression, expansion (explosion) and exhaust cycles, to generate output power. The internal combustion engine 1 has a cylinder (combustion chamber) 2 formed in the interior thereof. Fuel explosion power (or fuel combustion power) generated in the cylinder 2 is converted into a rotational power of a crankshaft (not shown) by means of a piston 3 and a connecting rod 4.

On the cylinder 2, there is provided an intake port 5A that constitutes the most downstream portion of an intake passage 5 and an exhaust port 6A that constitutes the most upstream portion of an exhaust passage 6. The interface between the intake port 5A and the cylinder 2 is closed/opened by an intake valve 7. On the other hand, the interface between the exhaust port 6A and the cylinder 2 is opened/closed by an exhaust valve 8.

The internal combustion engine 1 has a fuel injection valve 9. The fuel injection valve 9 is an electro-magnetically driven valve that is adapted to inject fuel (gas oil) pressurized by a high pressure pump or the like into the cylinder 2 by an appropriate quantity at suitable timing.

The exhaust passage 6 is a passage (exhaust gas passage) for exhaust gas discharged from the cylinder 2. In the exhaust passage 6, there is provided an exhaust gas purifying portion 10 that removes NOx, HC (carbon hydride) and CO (carbon monoxide) etc. contained in the exhaust gas.

The exhaust gas purifying portion 10 includes, in the following order from upstream to downstream, an S-trapping (sulfur-trap) catalyst 11 that constitutes the first sulfur trapping means in the present invention, an S-trapping catalyst 12 that constitutes the second sulfur trapping means in the present invention, a reducing agent activating catalyst 13 that constitutes the reducing agent activating means in the present invention, and an NOx storage reduction catalyst (which will be referred to as NOx catalyst hereinafter) 14.

In this embodiment, a reducing agent adding valve 15 used for adding reducing agent is provided in the exhaust passage 6 between the two S-trapping catalysts 11 and 12. The reducing agent adding valve 15 is an electro-magnetically driven valve similar to the fuel injection valve 9. The reducing agent adding valve 15 is adapted to supply fuel (gas oil) that functions as a reducing agent into the exhaust passage 6 between the two S-trapping catalysts 11 and 12 by an appropriate quantity at suitable timing. The reducing agent adding valve 15 constitutes the reducing agent adding means in the present invention.

To the internal combustion engine 1 having the above-described structure, an electronic control unit (ECU) 20 for controlling the internal combustion engine 1 is annexed. The ECU 20 includes logical arithmetic circuits such as a central processing unit (CPU), a read only memory (ROM), a random access memory (RAM) and a backup RAM. The ECU 20 detects, for example, the running state of the internal combustion engine 1 based on signals from various sensors and controls various components of the internal combustion engine 1 overall.

The ECU 20 having the above-described configuration receives detection signals of various sensors via an external input circuit and performs various controls concerning the running conditions of the internal combustion engine 1, such as control for opening/closing the fuel injection valve 9 and the reducing agent adding valve 15, based on the detection signals received.

In the following, the NOx catalyst 14 will be described more specifically.

When the air-fuel ratio of the exhaust gas flowing into the NOx catalyst 14 is a lean air fuel ratio (i.e. higher than the theoretical air-fuel ratio, or when the exhaust gas is an oxidizing atmosphere), it stores NOx contained in the exhaust gas flowing into the catalyst so as not to emit it to the atmosphere. On the other hand, when the air fuel ratio of the exhaust gas flowing into the NOx catalyst 14 is a rich air-fuel ratio or equal to the theoretical air fuel ratio (i.e. equal to or smaller than the theoretical air-fuel ratio, or when the exhaust gas is a reducing atmosphere), it reduces (or deoxidizes) and removes the NOx stored in it.

Accordingly, when the internal combustion engine 1 is operated under lean combustion, the air-fuel ratio of the exhaust gas discharged from the internal combustion engine 1 becomes a lean atmosphere (i.e. oxidizing atmosphere) and the oxygen concentration in the exhaust gas becomes high. Therefore, NOx contained in the exhaust gas is stored in the NOx catalyst 14. However, if the lean combustion running of the internal combustion engine 1 continues for a long time, the NOx storage capacity of the NOx catalyst 14 is saturated, and NOx contained in the exhaust gas is not stored in the NOx catalyst 14 but emitted to the atmosphere.

Especially in the case of a diesel engine like this internal combustion engine 1, what is burned in most of its operation range is air-fuel mixture having a lean air-fuel ratio, and the air-fuel ratio of the exhaust gas is a lean air-fuel ratio in most of the operation range accordingly. Therefore, the NOx storage capacity of the NOx catalyst 14 is easy to be saturated. Here, the lean air-fuel ratio refers, in the case of diesel engines, to air-fuel ratios A/F in the range from 20 to 50 in which NOx cannot be removed by three way catalysts.

In view of the above, when the internal combustion engine is operated under lean combustion, it is needed to reduce the oxygen concentration in the exhaust gas flowing into the NOx catalyst 14 and increase the concentration of the reducing agent before the NOx storage capacity of the NOx catalyst 14 is saturated to thereby reduce (or deoxidize) the NOx stored by the NOx catalyst 14. To this end, the ECU 20 effects what is called rich spike control to change the air-fuel ratio of the exhaust gas flowing into the NOx catalyst 14 into a rich air-fuel ratio in a spike-like manner (for a short time) with a relatively short cycle.

In this rich spike control, a determination is made at predetermined intervals by the ECU 20 as to whether a condition for executing the spike control is met or not. The condition for executing the rich spike control may be, for example, that the NOx catalyst 14 is in an active state or that the output signal value of the exhaust temperature sensor (or the exhaust gas temperature) is lower than a specific upper limit value.

If it is determined that the condition for executing the rich spike control is met, the ECU 20 performs a control to increase the concentration of the reducing components in the exhaust gas by additively supplying fuel (gas oil) serving as a reducing agent to the exhaust passage in a spike-like manner by direct addition through the reducing agent adding valve 15, thereby causing the air-fuel ratio of the exhaust gas flowing into the NOx catalyst 14 to be temporarily made equal to a predetermined target rich air-fuel ratio.

The exhaust gas of a rich air-fuel ratio thus formed flows into the NOx catalyst 14 to reduce the NOx stored by the catalyst.

In this way, the air-fuel ratio of the exhaust gas flowing into the NOx catalyst 14 alternates between a “lean” air-fuel ratio and a “spike-like rich target air fuel ratio” with a relatively short cycle. Thus, storage and reductive discharge of NOx can occur in the NOx catalyst alternately with a short cycle.

Next, a description will be made of features of this embodiment.

When the above-described rich spike control is effected, fuel (gas oil) serving as a reducing agent is additively supplied into the exhaust gas passage. In this process, if the gas oil flows directly into the NOx catalyst 14, the NOx catalyst 14 will be poisoned by sulfur components contained in the exhaust gas. In view of this, in a conventional art, low sulfur fuel in which the concentration of sulfur components is low is supplied to the NOx catalyst to reduce poisoning of the NOx catalyst with sulfur. However, low sulfur fuel contains sulfur components in effect, and it is very difficult to eliminate sulfur components.

Given the above situation, according to this embodiment, the additional S-trapping catalyst 12 is provided in addition to the S-trapping catalyst 11.

The S-trapping catalyst 11 is provided upstream of the position in the exhaust passage at which the reducing agent adding valve 15 additively supplies reducing agent and traps sulfur components contained in the exhaust gas discharged from the internal combustion engine 1.

The S-trapping catalyst 12 is provided downstream of the position at which the reducing agent adding valve 15 additively supplies reducing agent into the exhaust passage and upstream of the NOx catalyst 14. After sulfur components are trapped by the S-trapping catalyst 11, the S-trapping catalyst 12 traps sulfur components contained in the exhaust gas to which reducing agent has been additively supplied through the reducing agent adding valve 15.

Between the S-trapping catalyst 12 and the NOx catalyst 14, there is further provided a reducing agent activating catalyst 13 for activating the reducing agent from which sulfur components have been trapped by the S-trapping catalyst 12.

In the following, a description will be made of the S-trapping catalyst 12.

The S-trapping catalyst 12 characteristically has a strong basicity relative to the NOx catalyst 14. With this feature, when reducing agent is additively supplied through the reducing agent adding valve 15, the S-trapping catalyst traps sulfur components contained in the exhaust gas to which reducing agent has been additively supplied.

Here, a description will be made of the basicity of the S-trapping catalyst 12.

Since the sulfur component storage capacity of the S-trapping catalyst is eventually saturated, it had been conventionally required to effect regeneration processing for desorbing (reducing) sulfur components to remove them from the S-trapping catalyst. To this end, it had been necessary to design the S-trapping catalyst to have a basicity within the range that allows desorption of sulfur components from the catalyst. (If the basicity of the S-trapping catalyst is excessively high, desorption is impossible in some cases.)

However in recent years, the sulfur content in fuel (gas oil) has been decreasing, and it is not necessary to effect regeneration processing for the S-trapping catalyst. In the case where such a fuel is used as the reducing agent, the S-trapping catalyst may have a stronger basicity, and therefore, it is possible to trap sulfur components more reliably.

Next, a description will be made of a reducing agent activating catalyst 13.

The reducing agent activating catalyst 13 may be, for example, an oxidation catalyst. When an oxidation catalyst is used as the reducing agent activating catalyst 13, reducing agent from which sulfur components have been removed by the S-trapping catalyst 12 is oxidized by the oxidation catalyst. Since the oxidation is an exothermic reaction, the temperature of the NOx catalyst 14 rises. The reducing agent is pyrolytically decomposed and partially oxidized, so that components having a low boiling point (i.e. components easy to be evaporated or components having a low density) are generated. Accordingly, activity of the reducing agent flowing into the NOx catalyst 14 is enhanced.

Since reactivity of the reducing agent in the NOx catalyst 14 can be enhanced as per the above, it is possible to increase efficiency in reducing NOx in the NOx catalyst 14, thereby making it possible to further enhance the NOx removing rate.

Next, a description will be made of NOx storage capacity in each of the S-trapping catalyst 12, the reducing agent activating catalyst 13 and the NOx catalyst 14.

Since the sulfur component storage capacity of the S-trapping catalyst 12 can be considered as an NOx storage capacity, the NOx storage capacity in each catalyst will be described in this embodiment.

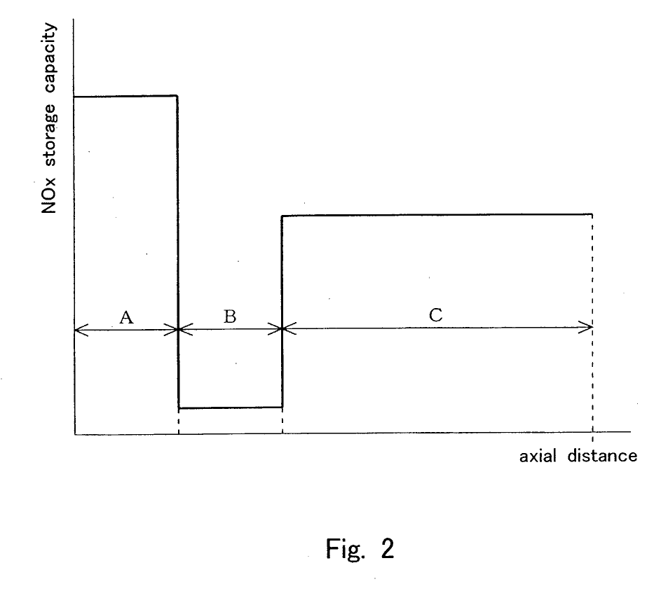

FIG. 2 shows the NOx storage capacity (stored amount) in the S-trapping catalyst 12, the reducing agent activating catalyst 13 and the NOx catalyst 14. In FIG. 2, the vertical axis represents the NOx storage capacity and the horizontal axis represents the distance along the axial direction (direction along which the exhaust gas flows in the exhaust passage 6). Regions indicated by A, B and C in FIG. 2 corresponds to the S-trapping catalyst 12, the reducing agent activating catalyst 13 and the NOx catalyst 14 respectively.

In FIG. 2, the NOx storage capacity in area C or the NOx storage capacity of the NOx catalyst 14 represents the storage capacity of a typical NOx catalyst.

The NOx storage capacity in area A or the NOx storage capacity of the S-trapping catalyst 12 is designed to be larger than the NOx storage capacity in area C. This is attained by making the basicity of the S-trapping catalyst 12 larger than that of the NOx catalyst 14.

The NOx storage capacity in area B or the NOx storage capacity of the reducing agent activating catalyst 13 is designed to be smaller than the NOx storage capacity in area C.

By making the NOx storage capacity of the S-trapping catalyst 12 larger than the NOx storage capacity of the NOx catalyst 14 as described above, when reducing agent is additively supplied through the reducing agent adding valve 15, sulfur components contained in the exhaust gas to which reducing agent has been additively supplied can be trapped more reliably.

As per the above, according to this embodiment, it is possible to trap sulfur components contained in the exhaust gas discharged from the internal combustion engine 1 by means of the S-trapping catalyst 11, and in addition when reducing agent is additively supplied into the exhaust passage 6 through the reducing agent adding valve 15, it is possible to trap sulfur components contained in the exhaust gas to which reducing agent has been additively supplied by means of the S-trapping catalyst 12.

Therefore, it is possible to decrease sulfur components flowing into the NOx catalyst 14, whereby the NOx removing rate of the exhaust gas purifying portion 10 (NOx catalyst 14) can be kept high.

### Embodiment 2

In the above-described embodiment 1, the S-trapping catalyst 12, the reducing agent activating catalyst 13 and the NOx catalyst 14 are separate, different catalysts. In embodiment 2 of the present invention, the functions of these catalysts are realized by a single catalyst.

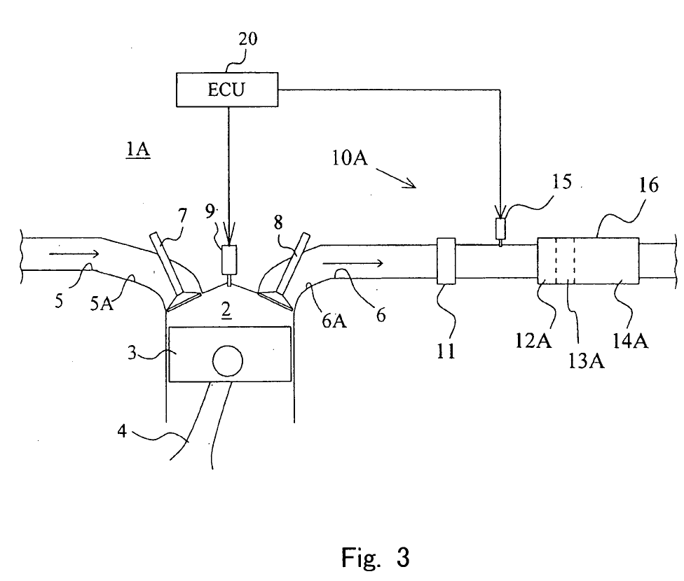

FIG. 3 schematically shows an internal combustion engine 1A according to embodiment 2 of the present invention. The structure of the internal combustion engine 1A according to this embodiment is similar to that of the internal combustion engine 1 according to the above-described embodiment, and the elements same as those in embodiment 1 are designated by the same reference signs and descriptions thereof will be omitted.

In an exhaust gas purifying portion 10A of this embodiment, there is provided, in the following order from upstream to downstream an S-trapping catalyst 11 that constitutes the first sulfur trapping means or the sulfur trapping means in the present invention and an NOx catalyst 16.

In the NOx catalyst 16 of this embodiment, there is provided, in the following order from upstream to downstream, an S-trapping portion 12A, a reducing agent activating portion 13A and an NOx storage portion 14A.

The S-trapping portion 12A constitutes the second sulfur trapping means or the upstream region among both end regions of the catalyst in the present invention. The S-trapping portion 12A has a function similar to the function of the S-trapping catalyst 12 described in the above description of embodiment 1. The reducing agent activating portion 13A constitutes the reducing agent activating means or the inner region of the catalyst in the present invention. The reducing agent activating portion 13A has a function similar to the function of the reducing agent activating catalyst 13 described in the above description of embodiment 1. The NOx storage portion 14A constitutes the catalyst or the downstream region among both end regions of the catalyst in the present invention. The NOx storage portion 14A has a function similar to the function of the NOx catalyst 14 described in the above description of embodiment 1.

As per the above, this embodiment is characterized by that the S-trapping portion 12A, the reducing agent activating portion 13A and the NOx storage portion 14A are integrally provided to constitute the NOx catalyst 16.

In the NOx catalyst 16, different storage materials are applied and supported on a single (common) substrate to form the S-trapping portion 12A, the reducing agent activating portion 13A and the NOx storage portion 14A.

In the following, a method of manufacturing the NOx catalyst 16 will be described.

Firstly, a storage material is applied and supported on the upstream front end portion and the downstream rear end portion of the substrate. The rear end portion is provided at the end opposite to the front end portion with an intermediate portion between. The density of the storage material supported on the front end portion is made higher than the density of the storage material on the rear end portion. In the intermediate portion, the quantity of the storage material is made smaller than that in the rear end portion, or alternatively, no storage material is supported on the intermediate portion.

In this way, the S-trapping portion 12A, the reducing agent activating portion 13A and the NOx storage portion 14A are formed in the front end portion, the intermediate portion and the rear end portion of the substrate respectively.

The NOx catalyst 16 thus formed also has the NOx storage capacity characteristic similar to that in embodiment 1 described with reference to FIG. 2.

Specifically, by making the storage material density in the S-trapping portion 12A higher than that of the NOx storage portion 14A, it is possible to make the NOx storage capacity of the S-trapping portion 12A larger than that of the NOx storage portion 14A. Thus, when reducing agent is additively supplied through the reducing agent adding valve 15, it is possible to trap sulfur components contained in the exhaust gas to which the reducing agent has been additively supplied with enhanced reliability. In this connection, in the case where the storage material is not supported on the intermediate portion (or the reducing agent activating portion 13A) of the substrate in this embodiment, region B shown in FIG. 2 has no (or little) NOx storage capacity.

As has been described in the foregoing, the advantageous effects same as those of embodiment 1 are also achieved in this embodiment. In addition, since this embodiment provides the advantageous effects same as embodiment 1 while using a single catalyst, downsizing of the exhaust gas purifying portion 10A can be achieved.

In this embodiment, the NOx catalyst 16 is formed by applying a storage material in different manners on a single substrate. However, this feature is not essential but other configurations in which an S-trapping portion 12A, a reducing agent activating portion 13A and an NOx storage portion 14A are integrally formed may be adopted. For example, an S-trapping portion 12A, a reducing agent activating portion 13A and an NOx storage portion 14A may be provided on separate substrates and accommodated in a single casing.

1. An exhaust gas purifying method for an internal combustion engine comprising:
a first step of trapping sulfur components contained in exhaust gas discharged from an internal combustion engine;
a second step of trapping NOx contained in the exhaust gas from which sulfur components have been trapped in said first step;
a third step of adding, in response to a reducing agent addition request, a reducing agent to the exhaust gas from which sulfur components have been trapped in said first step;
a fourth step of trapping sulfur components contained in the exhaust gas to which the reducing agent has been added in said third step; and
a fifth step of reducing NOx trapped in said second step by means of the reducing agent from which sulfur components have been trapped in said fourth step.

2. An exhaust gas purifying method for an internal combustion engine according to claim 1, further comprising a step of activating the reducing agent from which sulfur components have been trapped before reducing, in said fifth step, NOx trapped in said second step by means of the reducing agent from which sulfur components have been trapped in said fourth step.

3. An exhaust gas purifying apparatus for an internal combustion engine comprising:
first sulfur trapping means provided in an exhaust passage of an internal combustion engine for trapping sulfur components contained in exhaust gas discharged from the internal combustion engine;
a catalyst provided downstream of said first sulfur trapping means for trapping NOx contained in the exhaust gas from which sulfur components have been trapped by said first sulfur trapping means;
reducing agent adding means for adding, in response to a reducing agent addition request, a reducing agent to the exhaust gas from which sulfur components have been trapped by said first sulfur trapping means, at a position upstream of said catalyst; and
second sulfur trapping means for trapping sulfur components contained in the reducing agent added by said reducing agent adding means, at a position upstream of said catalyst.

4. An exhaust gas purifying apparatus for an internal combustion engine according to claim 3, further comprising reducing agent activating means provided between said second sulfur trapping means and said catalyst for activating the reducing agent from which sulfur components have been trapped by the second sulfur trapping means.

5. An exhaust gas purifying apparatus for an internal combustion engine comprising:
sulfur trapping means provided in an exhaust passage of an internal combustion engine for trapping sulfur components contained in exhaust gas discharged from the internal combustion engine;
a catalyst provided downstream of said sulfur trapping means for trapping NOx contained in the exhaust gas from which sulfur components have been trapped by said sulfur trapping means; and
reducing agent adding means for adding, in response to a reducing agent addition request, a reducing agent to the exhaust gas from which sulfur components have been trapped by said sulfur trapping means, at a position upstream of said catalyst,
wherein both ends regions of said catalyst have an NOx storage capacity larger than that of an inner region of the catalyst.

6. An exhaust gas purifying apparatus for an internal combustion engine according to claim 5, wherein the upstream region among said both end regions of said catalyst has an NOx storage capacity larger than that of the downstream region among said both end regions.
